(19) United States
(12) Patent Application Publication
(10) Pub. No.: US 2013/0202148 A1
(43) Pub. Date: Aug. 8, 2013

(54) ACTIVE MUFFLER

(71) Applicant: EBERSPÄCHER EXHAUST TECHNOLOGY GMBH & CO. KG, Neunkirchen (DE)

(72) Inventors: Johannes GRUPP, Donzdorf (DE); Manfred NICOLAI, Esslingen (DE); Thomas SCHLICHT, Esslingen (DE); Michael POMMERER, Uhingen (DE); Jan KRÜGER, Neuhausen (DE); Georg WIRTH, Kirchheim/Teck (DE)

(73) Assignee: EBERSPÄCHER EXHAUST TECHNOLOGY GMBH & CO. KG, Neunkirchen (DE)

(21) Appl. No.: 13/759,259

(22) Filed: Feb. 5, 2013

(30) Foreign Application Priority Data
Feb. 6, 2012 (DE) 10 2012 201 725.9

(51) Int. Cl. H04R 1/02

(52) U.S. Cl. CPC H04R 1/025
USPC 381/389

(57) ABSTRACT

An active muffler (1) for an exhaust system (13) of an internal combustion engine is provided with a housing (2), which has an upper shell (3) as well as a lower shell (4) and which defines an inner space (5). A loudspeaker (6) is arranged in inner space (5). A sound conduction channel (10) acoustically connects a membrane (9) of loudspeaker (6) to a connecting branch (11). A low-cost design is obtained if sound conduction channel (10) is formed integrally in the lower shell (4).

### CROSS REFERENCE TO RELATED APPLICATIONS

This application claims the benefit of priority under 35 U.S.C. §119 of German Patent Application DE 10 2012 201 725.9 filed Feb. 6, 2012, the entire contents of which are incorporated herein by reference.

### FIELD OF THE INVENTION

The present invention pertains to an active muffler (also known as active silencer) for an exhaust system of an internal combustion engine, preferably of a motor vehicle, with a housing which defines an inner space and with a loudspeaker. The present invention also pertains to a kit for manufacturing such mufflers.

### BACKGROUND OF THE INVENTION

An active muffler, which has a housing, which has an upper shell as well as a lower shell and defines an interior space, is known from DE 10 2008 018 085 A1. The muffler also comprises a loudspeaker, which is arranged in the interior space, where a membrane of the loudspeaker is acoustically connected to a connecting branch of the muffler by means of a funnel-shaped sound conduction channel. The muffler can be connected acoustically to a section of the exhaust system carrying exhaust gas, for example, an exhaust pipe, by means of this connecting branch. The acoustic coupling makes possible the transmission of pressure pulsations, which can be generated by means of the membrane of the loudspeaker, from this membrane into the exhaust gas stream of the exhaust system. The acoustic pattern of the sound being transported in the exhaust gas can thus be influenced by means of such an active muffler, and certain frequencies can be specifically muffled especially by interferences or by extinction.

In a prior-art muffler, the sound conduction channel is arranged in a separate sound conduction body, which is enclosed by the lower shell, such that a lower cavity is formed between the sound conduction body and the lower shell. The upper shell envelopes the loudspeaker while forming an upper cavity, and the loudspeaker is supported with its electromagnetic drive on the upper shell on a side facing away from the membrane. Furthermore, a separate bracket, which is fastened, on the one hand, to the lower shell and to which the loudspeaker is fastened with its cage, on the other hand, is provided in the prior-art muffler. The bracket defines within the housing a bypass, which acoustically connects the upper cavity to the lower cavity. The back volume of the loudspeaker can be enlarged in this manner into the lower cavity of the lower shell.

In addition, the upper shell is equipped in the prior-art muffler with a cable connection, through which a cable can be passed for actuating the loudspeaker and which may at the same time be designed as a pressure equalization opening.

### SUMMARY OF THE INVENTION

An object of the present invention is to provide an improved embodiment, which is characterized especially by a comparatively low-cost manufacturability, for a loudspeaker of the type described in the introduction.

According to the invention an active muffler for an exhaust system of an internal combustion engine is provided. The active muffler comprises a housing having an upper shell and a lower shell, the housing defining an inner space. A loudspeaker is arranged in the inner space. The loudspeaker includes a membrane. A connecting branch is operatively connected to the exhaust system. A sound conduction channel acoustically connects the membrane of the loudspeaker to the connecting branch. The sound conduction channel is formed integrally with the lower shell.

The present invention is based on the general idea of integrating the sound conduction channel into the lower shell. As a consequence, a separate sound conduction body to embody the sound conduction channel can be eliminated. As a result, at least one component, namely, the sound conduction body, is eliminated compared to a conventional muffler. At the same time, a cavity between lower shell and sound conduction body is eliminated according to the present invention, so that the lower shell does not contribute to the back volume of the loudspeaker in the area of the sound conduction channel in the muffler according to the present invention. As a result, the lower shell has an extremely compact design, which simplifies the accommodation of the muffler in the always crowded installation situations, especially in a motor vehicle.

The sound conduction channel preferably has a funnel-shaped design. As a consequence, the cross section of the sound conduction channel tapers in the sound propagation direction from the loudspeaker or from the membrane to the connecting branch. Consequently, a comparatively large loudspeaker with a correspondingly large membrane can be mounted in the housing, as a result of which especially sound waves with lower frequencies can be generated and radiated in the direction of the exhaust gas stream.

Corresponding to an advantageous embodiment, the loudspeaker is fastened to the lower shell. Direct fastening of the loudspeaker to the lower shell is preferred, in particular. The loudspeaker advantageously has a cage, at which the membrane is held, on the one hand, and which carries, on the other hand, an electromagnetic drive for driving the membrane. The loudspeaker is then fastened to the lower shell preferably by means of the cage of the loudspeaker. Any desired and suitable fastening means may be used, in principle. For example, screw connections are advantageous.

Furthermore, it may be advantageous to fasten the loudspeaker exclusively to the lower shell, so that the upper shell does not contribute to the fixation of the loudspeaker to the housing. Corresponding to another advantageous embodiment, provisions may be made for the loudspeaker to be arranged in the housing without contact with the upper shell. Interactions between loudspeaker and upper shell can thus be avoided. At the same time, the geometry of the upper shell can be selected as a result more or less independently from the loudspeaker. On the one hand, the cavity enveloped by the upper shell can be dimensioned as a result specifically such that a sufficient back volume can be made available for the loudspeaker. Furthermore, this mode of construction facilitates a geometric adaptation of the upper shell to the particular installation situation. Existing spaces available for installation can thus be better utilized.

It is proposed in another advantageous embodiment that the loudspeaker be clamped against the lower shell by means of the upper shell. In other words, the loudspeaker is fixed at the lower shell only by fastening the upper shell to the lower shell, with the upper shell and lower shell forming a clamped fixation for the loudspeaker. The holding-down contour of the upper shell preferably extends over an outer edge of the loudspeaker, e.g., an outer edge of the cage of the loudspeaker, and presses same against a contact surface of the lower shell. The holding-down contour may be a closed circumferential shoulder or comprise a plurality of separate holding-down devices arranged distributed in the circumferential direction. The holding-down contour is preferably formed integrally with the upper shell. An embodiment in which the loudspeaker has no contact with the upper shell aside from the clamped fixation is preferred here as well, so that the above-mentioned advantages also arise here.

According to an advantageous embodiment, the lower shell may have at least one pressure equalization opening, which connects the inner space to the area surrounding the housing. Static pressure differences between the surrounding area and the inner space can be compensated by means of such a pressure equalization opening. Such pressure differences, which may arise, e.g., due to temperature changes, do affect the static deflection of the membrane and hence the frequency of the sound radiated. In addition, permanent deflection of the membrane from its neutral position due to creep processes may lead to permanent deformation of the membrane. The functionality of the lower shell is increased at the same time due to the integration of the pressure equalization opening in the lower shell, which makes it simple to achieve the least expensive manufacturability possible for the upper shell.

Corresponding to a variant, the corresponding pressure equalization opening may be closed with a gas-permeable and liquid-tight membrane. For example, the entry of water into the inner space of the muffler, e.g., due to splash water, can be extensively ruled out by means of such a membrane, while sufficient pressure equalization is possible at the same time. Furthermore, water of condensation, which may be formed in the inner space, can evaporate through such a membrane.

The corresponding membrane may be preferably embedded in the material of the lower shell. The lower shell may be preferably manufactured from a plastic, with injection molding being preferred. The corresponding membrane in the area of the opening to be formed can already be inserted into the injection mold during injection molding, so that the lower shell is molded quasi integrally with the corresponding membrane, so that the membrane is then embedded on the edge side into the material of the lower shell. The functionality of the lower shell is improved hereby at the same because, e.g., the splash guard created by means of the membrane is integrated into the lower shell.

Moreover, provisions may be made in another embodiment for the lower shell to have a cable connection, via which the loudspeaker can be actuated. The functionality of the lower shell is increased hereby as well, as a result of which the possibility of low-cost manufacturability of the upper shell is improved at the same time. Such a cable connection may be designed in the simplest case as a cable bushing, through which a corresponding cable for actuating the loudspeaker can be passed through the lower shell. It is possible, furthermore, to design the cable connection as a plug-type component or a jack component, which has electric contacts, which are connected via an internal cables with corresponding contacts of the loudspeaker. A complementary component of an external cable can then be connected to the jack component or to the plug component. The corresponding cable connection may be formed integrally in one piece in the lower shell. If the components, e.g., electric contacts or a jack element or a plug element, are necessary to embody the cable connection, these may be extrusion-coated with or embedded in the material of the lower shell.

The lower shell is preferably a plastic component, which may be manufactured according to an especially advantageous embodiment from a reinforced plastic. The plastic may be fiber-reinforced, glass fiber reinforcement being preferred. The plastic may be reinforced, in addition, with short-staple fibers, in which case short-staple glass fiber reinforcement is preferred. Such a short-stable fiber reinforcement is suitable for injection molding the lower shell from the plastic. The lower shell has a comparatively high stability due to the use of the reinforced plastic. Furthermore, increased temperature resistance can especially also be imparted hereby to the lower shell. As a result, the lower shell is especially suitable for the integration or attachment of the largest possible number of components of the muffler. Furthermore, the lower shell can be mounted as a result better on a side of the muffler facing the hot exhaust gas system. The lower shell is equipped for this with the connecting branch, via which the muffler can be acoustically connected to an exhaust gas-carrying section of the exhaust system.

Corresponding to another advantageous embodiment, the loudspeaker and the upper shell may be attached to the lower shell in the same mounting direction. This leads to favorable accessibility to the mounting points, which simplifies the manufacture of the muffler.

According to another advantageous embodiment, the lower shell may have a closed, circumferential flange, which projects radially outwardly in relation to a mounting direction, in which the loudspeaker is attached to the lower shell and at which the upper shell is supported axially and/or fastened in relation to the mounting direction with a closed, circumferential edge. This leads to an especially simple possibility of fastening between upper shell and lower shell, which is tolerant to thermal expansion effects, on the one hand, and permits comparatively large manufacturing tolerances, on the other hand.

Corresponding to an advantageous variant, the loudspeaker and the upper shell may be fastened to the flange in the area of a common fastening plane, which extends radially in relation to the mounting direction. The lower shell has an extremely compact design as a result. The back volume of the loudspeaker is determined in this mode of construction almost exclusively by the geometry of the upper shell. As an alternative, an embodiment is also conceivable in which the loudspeaker and the upper shell are fastened in different planes to the flange of the lower shell, which planes are located at spaced locations from one another in the mounting direction and extend each at right angles to the mounting direction. The flange may have for this, e.g., a circumferential collar, which projects axially in relation to the mounting axis and makes possible the mounting of the upper shell at the edge. The edge of the flange enclosed in such an embodiment a space that contributes to the back volume of the loudspeaker in this case.

Provisions may advantageously be made for a pressure sensor, e.g., a microphone, to be arranged at the lower shell inside or outside. The pressure sensor is connected to a pressure transmission line, which is connected, with the muffler attached to the exhaust system, to a section of the exhaust system, which is located downstream of the connecting branch regarding the exhaust gas flow in the exhaust system. The pressure transmission line makes possible an acoustic connection between the exhaust gas flow path of the exhaust system downstream of the connecting branch and the pressure sensor. The signals detected by means of the pressure sensor make it possible to control the effectiveness with which the airborne sound is influenced or with which the airborne sound is muffled, especially in the manner of a regulating means. By accommodating the pressure sensor at or in the lower shell, the function density of the lower shell can be increased. With a control arranged outside the loudspeaker for actuating the loudspeaker, the electric signals of the pressure can be sent through the same cable via which the loudspeaker is also actuated. However, if the control unit is accommodated in the housing, preferably on or in the lower shell, the signal transmission takes place within the muffler, which reduces the amount of cable needed.

A control for actuating the loudspeaker may be arranged, in particular, in a cavity, which is formed on an inner side of the lower shell facing the inner space of the housing or the loudspeaker. An opening of the cavity is preferably closed by a cover, which is designed as a heat guard and consists, for example, of a metal or a metal alloy. For example, said cavity is recessed in a wall defining the sound conduction channel. The cover now preferably forms a section of this wall.

If the pressure sensor and the control unit are accommodated on or in the housing or on or in the lower shell, a common cable arriving from the housing or led out of the housing is sufficient to supply the electric components with power. In addition, a signal cable, which makes it possible to feed external signals, e.g., wishes of the driver, may also be integrated in this common cable to influence the sound and/or the volume.

While the loudspeaker, which usually has a metallic cage, is advantageously screwed or clamped to the lower shell, the upper shell may be bonded or welded to the lower shell. However, a screw connection is also conceivable here as an alternative.

The connecting branch may be formed in another embodiment by a pipe section that is separate from the lower shell and is arranged at a spaced location from the loudspeaker on the lower shell. While the lower shell is preferably a plastic part, the pipe section is preferably a metal component, which can be connected to an exhaust gas-carrying section of the exhaust system, which said section is likewise regularly manufactured from metal, in a suitable manner. The pipe section may, for example, be inserted into the lower shell. It is also possible to arrange the pipe section in an injection mold already during the manufacture of the lower shell, so that the pipe section is extrusion-coated by the plastic of the lower shell. The pipe section is embedded in this case in the material of the lower shell.

Furthermore, a bracket, by means of which the housing can be fastened to a component of the exhaust system, may be provided on the housing. Such a bracket is advantageously a separate component relative to the housing. In particular, the bracket is manufactured from metal. An embodiment in which the bracket is fastened to the lower shell is preferred in this connection. According to a preferred embodiment, the muffler is fastened to the exhaust system exclusively via the lower shell, as a result of which the upper shell if fully relieved of this task and can be manufactured at a correspondingly low cost.

According to another advantageous embodiment, the lower shell may have all essential components of the muffler aside from the upper shell, i.e., with the exception of the upper shell, and form with these a pre-assemblable, quasi modular unit, which can be completed into the muffler by putting on the upper shell. In other words, the muffler can be pre-assembled by means of the lower shell to the extent that only the upper shell must be arranged on it to complete the muffler. A modular system is created in this manner, which makes it possible, in particular, by means of lower shells of an identical design to create modular units of an essentially identical design, which make it possible to form variants of the muffler by means of upper shells of different shapes. The different upper shells differ above all by different geometries, which are adapted to different installation situations. As a result, the muffler can be adapted to different installation situations in a comparatively simple manner, namely, by only replacing the upper shell or by selecting a suitable upper shell. In particular, it is thus possible to embody an active muffler, which can be used in different vehicle models, and only upper shells of different shapes are used in different vehicle models depending on the installation situation. These upper shells can be manufactured at a comparatively low cost, because they have essentially only the function of separating the inner space of the muffler from the area surrounding the muffler. Thus, the upper shell is used essentially only to define the back volume of the loudspeaker. In addition, the muffler can preferably be mounted such that the upper shell is located on a side of the muffler facing away from the hot exhaust gas line, so that the upper shell can be preferably manufactured from a comparatively low-cost plastic, which does not have to have an especially high temperature resistance. At least the loudspeaker is an essential component of the muffler here.

The present invention also presents a kit for manufacturing active mufflers of the above-described type. Such a kit is characterized by identical lower shells and different upper shells. Modular units of a largely identical design, which comprises all essential components of the muffler with the exception of the upper shell, namely, preferably the loudspeaker and the connecting branch as well as—if present—a pressure equalization opening and/or a cable connection and/or a microphone and/or a control unit, can be created by means of the same lower shells. The different upper shells now make it possible to adapt the particular muffler to different installation situations. All upper shells have for this a constant edge area and, aside from this, geometries that can vary quasi as desired. An interface is then created via the respective edge area for mounting the corresponding upper shell on the lower shell.

It is apparent that the above-mentioned features, which will also be explained below, may be used not only in the particular combination described, but also in other combinations or alone, without going beyond the scope of the present invention.

Preferred embodiments of the present invention are shown in the drawings and will be explained in more detail in the following description, where identical reference numbers designate identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic highly simplified longitudinal sectional view through an active muffler according to the invention;

FIG. 2 is a schematic isometric view of an exhaust system in the area of such an active muffler;

FIG. 3 is a schematic longitudinal sectional view, similar to that of FIG. 1, but for another embodiment according to the invention.

### DESCRIPTION OF THE PREFERRED EMBODIMENTS

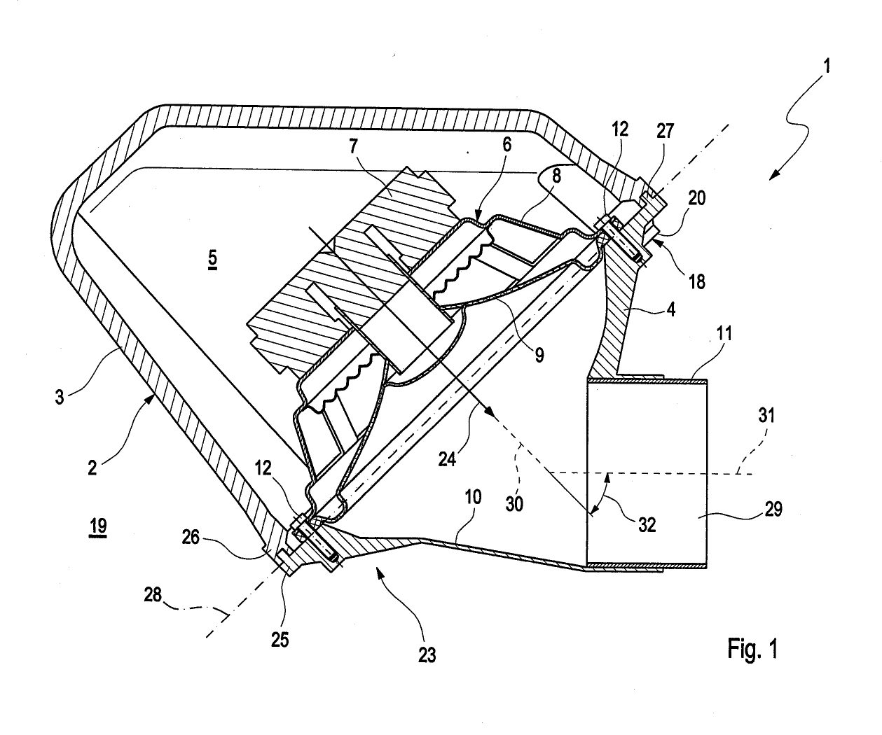

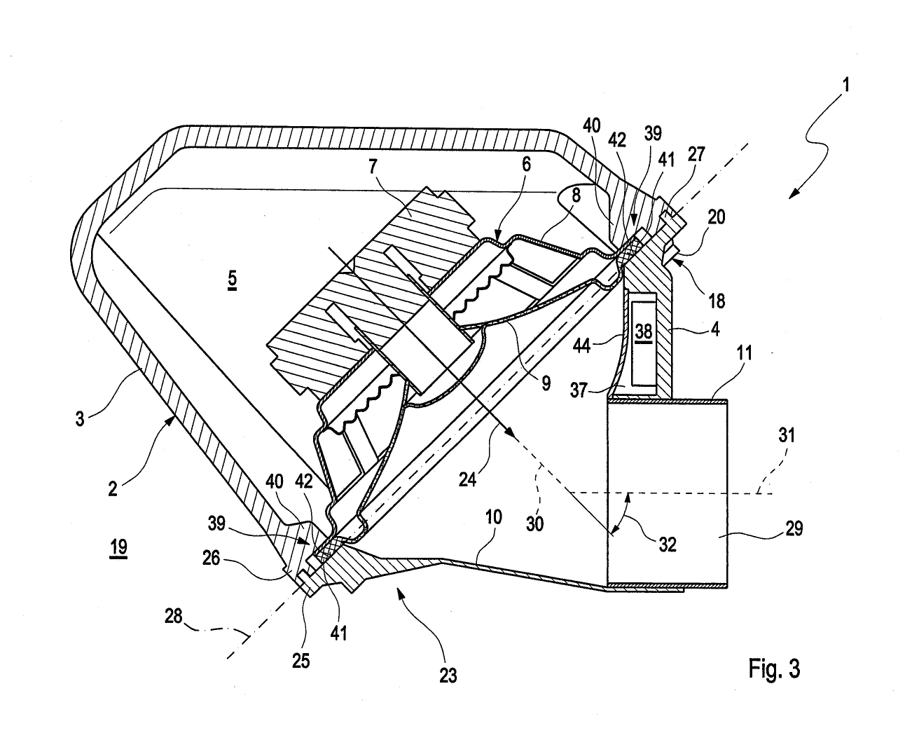

Referring to the drawings in particular, corresponding to FIGS. 1 and 3, an active muffler 1 comprises a housing 2, which has an upper shell 3 and a lower shell 4. Housing 2 defines in this case, an inner space 5, in which a loudspeaker 6 is arranged. Loudspeaker 6 comprises in the usual manner an electromagnetic drive 7, a cage 8 and a membrane 9. Drive 7 drives membrane 9 to generate pressure pulses or sound waves. Cage 8 stretches out the membrane 9, on the one hand, and carries drive 7, on the other hand.

Muffler 1 also comprises a preferably funnel-shaped sound conduction channel 10 as well as a connecting branch 11. Sound connection channel 10 acoustically connects membrane 9 to connecting branch 11, i.e., to transmit air-borne sound. Sound conduction channel 10 is formed integrally in lower shell 4 in the muffler 11 being shown here. This means that an area of an inner side of the lower shell 4 facing the inner space 5 defines the sound conduction channel 10.

As can be seen in FIG. 1, loudspeaker 6 is fastened via its cage 8 exclusively to the lower shell 4. According to FIG. 1, corresponding screw connections 12 may be advantageously used for this. Furthermore, loudspeaker 6 is arranged such that it has no contact with upper shell 3.

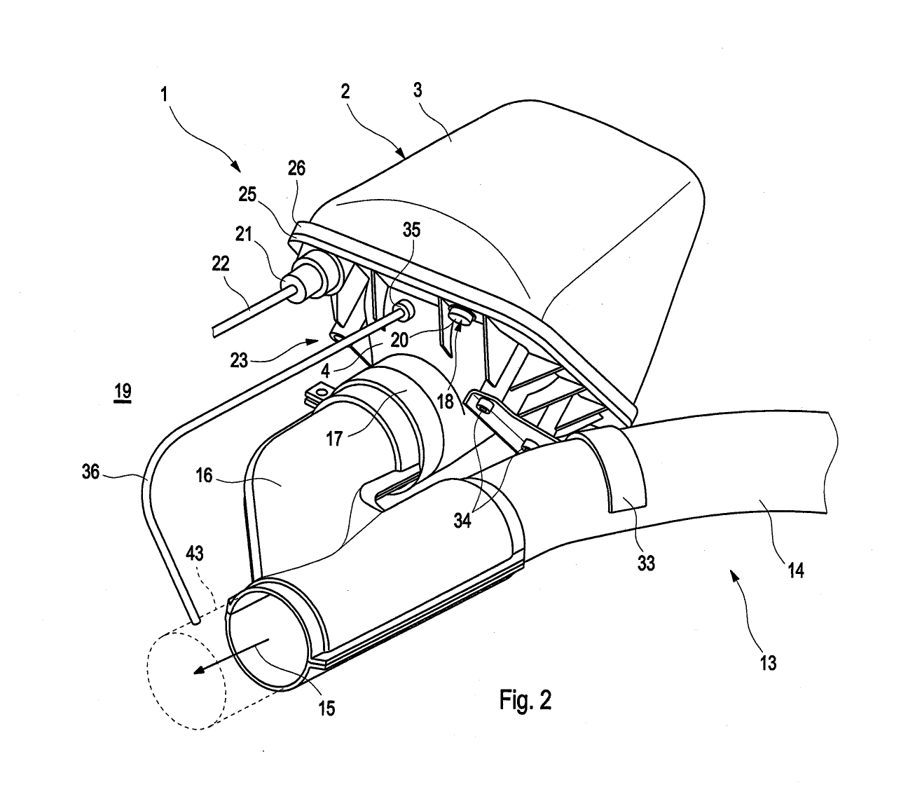

Corresponding to FIG. 2, muffler 1 is suitable for mounting on an exhaust system 13, which is shown in one area only in FIG. 2. Exhaust system 13 belongs to an internal combustion engine, not shown here, which is preferably located in a motor vehicle. Muffler 1 is acoustically connected to an exhaust gas-carrying section 14 of exhaust system 13, so that transmission of air-borne sound from loudspeaker 6 to or into an exhaust gas stream 15 indicated by an arrow in FIG. 2 is consequently possible. This connection is embodied in the example according to FIG. 2 by means of a Y-pipe 16, which is integrated in section 14 of exhaust system 1, on the one hand, and is connected, on the other hand, to connecting branch 11 (cf. FIG. 1) of muffler 1. For example, a clamp connection 17 may be used for this.

Corresponding to FIGS. 1 through 3, lower shell 4 is preferably equipped with at least one pressure equalization opening 18, which connects inner space 5 with an area 19 surrounding housing 2. Pressure equalization opening 18 is advantageously closed with a membrane 20, which is permeable to gas and impermeable to liquid. Splash water can thus be prevented from entering inner space 5, while the desired pressure equalization is at the same time possible between inner space 5 and the surrounding area 19. Furthermore, water of condensation formed in inner space 5, which evaporates in the inner space during corresponding heating can escape from inner space 5 through the pressure equalization opening 18 into the surrounding area 19. Membrane 20 may be embedded here in the material of lower shell 4, but this cannot be recognized here. Lower shell 4 is equipped here, besides with a cable connection 21, which is embodied in the example as a cable bushing, so that a cable 22, by means of which loudspeaker 6 can be actuated, can be led through lower shell 4 to loudspeaker 6.

Lower shell 4 is advantageously manufactured from a plastic, which is reinforced by means of short-staple fibers. As a result, lower shell 4 has a high dimensional stability and temperature resistance. Lower shell 4 is especially suitable as a result for the integration of a plurality of components of muffler 1. Contrary to this, upper shell 3 is advantageously manufactured from a simple, low-cost plastic, whose rigidity and temperature resistance are lower than the rigidity and temperature resistance of the lower shell 4.

Preferred are the embodiments being shown here, in which all essential components of muffler 1 with the exception of upper shell 3 are formed or arranged on the lower shell 4, so that lower shell 4 forms with these components a pre-assemblable unit 23, which has a quasi modular character. This unit 23 can be completed into the complete muffler 1 by the upper shell 3 being attached to it. It is thus possible to embody especially a kit or a modular system, which comprises identical lower shells 4 for embodying identical modular units 23 as well as at least two geometrically different upper shells 3.

Unit 23 comprises in the example the pipe section 29, loudspeaker 6, pressure equalization opening 18, cable connection 21 and bracket 33.

Loudspeaker 6 and upper shell 3 are attached to lower shell 4 in the embodiment being shown here in the same mounting direction 24 indicated by an arrow in FIGS. 1 and 3. Thus, axial mounting on the lower shell 4 is thus obtained for the loudspeaker 6 and for upper shell 3 concerning the mounting direction 24. Lower shell 4 is advantageously equipped with a closed, circumferential flange 25, which projects radially to the outside from the rest of the lower shell 4 in relation to the mounting direction 24. At its end facing the lower shell 4, upper shell 3 has a closed, circumferential edge 26, whose circumferential contour is made complementary with the circumferential contour of flange 25. Upper shell 3 is supported and fastened on flange 25 axially with its edge 26 in relation to the mounting direction 24. Upper shell 3 and lower shell 4 are, for example, welded together by means of a friction welding method. A corresponding, closed circumferential weld is designated by 27 in FIGS. 1 and 3.

Loudspeaker 6 and upper shell 3 are fastened to flange 25 in a common fastening plane 28 in the embodiments being shown here, this fastening plane 28 extending radially in relation to mounting direction 24.

Connecting branch 11 is embodied here by means of a separate pipe section 29, which is arranged on lower shell 4 at a spaced location from loudspeaker 6. Pipe section 29 is advantageously inserted into lower shell 4. Pipe section 29 may also be extrusion-coated with the material of lower shell 4. It is remarkable, besides, that a radiation direction 30 of loudspeaker 6, which is indicated by a broken line in FIG. 1, is inclined in the example by an angle 32, which equals about 45° in the example, in relation to a direction 31 in which connecting branch 11 exits, which direction is indicated by a broken line in FIG. 1.

In addition, a bracket 33 is provided according to FIG. 2, said bracket 33 being used to support loudspeaker 1 on exhaust system 13, here on a flow-carrying section 14, which is formed by a pipe here. This bracket 33 is fastened on the housing side to lower shell 4, e.g., by means of screw connections 34, so that muffler 1 is fastened to exhaust system 13 exclusively via lower shell 4, namely, via bracket 33 and connecting branch 11.

The screw connections 12 or other separate fastening elements, which are needed in the embodiment shown in FIG. 1 can be eliminated for fixing loudspeaker 6 in housing 2 or on lower shell 4 in the embodiment shown in FIG. 3. Loudspeaker 6 is clamped for this against lower shell 4 by means of upper shell 3. This means that loudspeaker 6 is fixed to lower shell 4 only by fastening upper shell 3 to lower shell 4, e.g., by welded connection 27. Upper shell 3 and lower shell 4 define a clamping fixation 39 for loudspeaker 6. A holding-down contour 40 of upper shell 3 advantageously extends for this over an outer edge 41 of loudspeaker 6 or of cage 8. With upper shell 3 attached to lower shell 4, holding-down contour 40 presses said outer edge 41 against a contact surface 42 of lower shell 4. Holding-down contour 40 may be a closed, circumferential shoulder or comprise a plurality of separate holding-down devices arranged distributed in the circumferential direction. Holding-down contour 40 is made integrally with upper shell 3 in the example shown in FIG. 3. An embodiment in which loudspeaker 6 has no contact with upper shell 3 aside from clamping fixation 39 is preferred here as well, so that the above-mentioned advantages also arise in this case.

Provisions may advantageously be made according to FIG. 2 for a pressure sensor 35, e.g., a microphone, to be arranged at lower shell 4 on the inside (not shown) or on the outside (shown). Pressure sensor 35 is connected to a pressure transmission line 36, which is connected, with muffler 1 attached to exhaust system 13, to a section 43 of exhaust system 13, which section is indicated by a broken line and is located downstream of connecting branch 29 or downstream of Y-pipe 16 defining the connection site in relation to the exhaust gas flow 15 in exhaust system 13. Pressure transmission line 36, e.g., a flexible tube or a pipe, makes possible an acoustic connection between the exhaust gas flow path of exhaust system 13 downstream of connecting branch 29 and pressure sensor 35. The signals detected by means of pressure sensor 35 make it possible to check the effectiveness with which the air-borne noise is influenced or with which air-borne sound is damped, especially in the manner of a regulating means. By accommodating pressure sensor 35 on or in lower shell 4, the function density of lower shell 4 can be increased. With a control unit arranged outside loudspeaker 6 for actuating loudspeaker 6, the electric signals of pressure sensor 35 can be sent through the same cable 22 via which loudspeaker 6 is actuated as well. However, if a control unit 38 for actuating loudspeaker 6 is accommodated, as in the embodiment shown in FIG. 3, in housing 2, preferably on or in lower shell 4, the signal transmission takes place within muffler 1, which reduces the amount of cable needed.

According to FIG. 3, control unit 38 for actuating loudspeaker 6 may be arranged in a cavity 37, which is formed on an inner side of lower shell 4 facing inner space 5 of housing 2 or loudspeaker 6. An opening of cavity 37 is preferably closed by a cover 44, which is designed as a heat guard and consists, for example, of a metal or a metal alloy. Said cavity 37 is recessed, for example, in a wall defining sound conduction channel 10. Cover 44 now preferably forms a section of this wall.

While specific embodiments of the invention have been shown and described in detail to illustrate the application of the principles of the invention, it will be understood that the invention may be embodied otherwise without departing from such principles.

What is claimed is:

1. An active muffler for an exhaust system of an internal combustion engine, the active muffler comprising:
a housing having an upper shell and a lower shell, the housing defining an inner space;
a loudspeaker arranged in the inner space, the loudspeaker including a membrane;
a connecting branch operatively connected to the exhaust system; and
a sound conduction channel which acoustically connects the membrane of the loudspeaker to the connecting branch, the sound conduction channel being formed integrally with the lower shell.

2. An active muffler in accordance with claim 1, wherein the loudspeaker is fastened to the lower shell.

3. An active muffler in accordance with claim 1, wherein the loudspeaker is clamped between the upper shell and the lower shell.

4. An active muffler in accordance with claim 1, wherein the loudspeaker is arranged without contact with the upper shell.

5. An active muffler in accordance with claim 1, wherein the lower shell comprises a pressure equalization opening, the pressure equalization opening connecting the inner space to an area surrounding the housing.

6. An active muffler in accordance with claim 5, wherein the pressure equalization opening is closed with a gas-permeable and liquid-tight membrane, the gas-permeable and liquid-tight membrane being embedded in material of the lower shell.

7. An active muffler in accordance with claim 1, wherein the lower shell comprises a cable connection, via which loudspeaker is actuated.

8. An active muffler in accordance with claim 1, wherein the lower shell is manufactured from a reinforced plastic.

9. An active muffler in accordance with claim 1, wherein the lower shell comprises all essential components of the active muffler with the exception of the upper shell and forms with these essential components a pre-assemblable unit, which can be completed into the active muffler by mounting the upper shell to the pre-assemblable unit.

10. An active muffler in accordance with claim 1, wherein the loudspeaker and the upper shell are attached to the lower shell in the same mounting direction.

11. An active muffler in accordance with claim 1, wherein the lower shell comprises a closed circumferential flange projecting radially outwardly in relation to a mounting direction, in which mounting direction the loudspeaker is attached to the lower shell, and on which circumferential flange the upper shell is axially supported and fastened in relation to the mounting direction with a closed circumferential edge.

12. An active muffler in accordance with claim 1, further comprising:
a pressure sensor arranged at lower shell; and
a pressure transmission line, wherein the pressure sensor is connected to a section of the exhaust system via the pressure transmission line.

13. An active muffler in accordance with claim 1, further comprising control unit for actuating loudspeaker, wherein an inner side of the lower shell has a cavity in which the control unit is arranged.

14. An active muffler in accordance with claim 1, wherein the connecting branch is formed by a separate pipe section arranged on the lower shell at a spaced location from the loudspeaker.

15. A kit for manufacturing an active muffler comprising a housing having an upper shell and a lower shell, the housing defining an inner space, a loudspeaker arranged in the inner space, the loudspeaker including a membrane, a connecting branch operatively connected to the exhaust system and a sound conduction channel which acoustically connects the membrane of the loudspeaker to the connecting branch, the sound conduction channel being formed integrally with the lower shell, the kit comprising:
identical lower shells; and
different upper shells.

16. An internal combustion engine exhaust system active muffler comprising:
an upper shell;
a lower shell and sound conduction channel formed as a single integral part, the lower shell and the upper shell being connected to form a housing defining an inner space;
a loudspeaker arranged in the inner space, the loudspeaker including a membrane;
a connecting branch operatively connected to the exhaust system, the sound conduction channel defining an airborne sound connection from the membrane of the loudspeaker to the connecting branch.

17. An active muffler in accordance with claim 16, wherein the loudspeaker is fastened only to the lower shell and the loudspeaker is arranged without contact with the upper shell.

18. An active muffler in accordance with claim 16, wherein the loudspeaker is clamped between the upper shell and the lower shell.

19. An active muffler in accordance with claim 16, wherein;
the lower shell comprises a pressure equalization opening, the pressure equalization opening connecting the inner space to an area surrounding the housing; and
the pressure equalization opening is closed with a gas-permeable and liquid-tight embedded in material of one of the upper shell and the lower shell.

20. An active muffler in accordance with claim 16, wherein the lower shell and the sound conduction channel formed as the single integral part are connected to the loudspeaker as a pre-assembled unit, which can be completed into the active muffler by mounting the upper shell to the pre-assembled unit.
